(19) United States
(12) Patent Application Publication
(10) Pub. No.: US 2010/0321627 A1
(43) Pub. Date: Dec. 23, 2010

(54) WAVELENGTH SELECTIVE OPTICAL ROTATOR AND OPTICAL HEAD DEVICE

(75) Inventor: Atsushi KOYANAGI, Fukushima (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: ASAHI GLASS CO., LTD., Tokyo (JP)

(21) Appl. No.: 12/870,136

(22) Filed: Aug. 27, 2010

Related U.S. Application Data
(63) Continuation of application No. PCT/JP09/53603, filed on Feb. 26, 2009.

(30) Foreign Application Priority Data
Feb. 27, 2008 (JP) 2008-046268

(51) Int. Cl. G02F 1/13

(52) U.S. Cl. 349/194

(57) ABSTRACT

A wavelength selective optical rotator includes a liquid crystal layer including a cholesteric-phase liquid crystal, wherein: when a first linearly polarized light having a wavelength λ₁ is incident on the liquid crystal layer, the liquid crystal layer converts the first linearly polarized light into a second linearly polarized light is a different linearly polarized light from the first linearly polarized light and outputs the latter; and when a linearly polarized light having a wavelength λ₂ that is longer than the wavelength λ₁ is incident on the liquid crystal layer, the liquid crystal layer outputs the linearly polarized light without changing its polarization state substantially.

### TECHNICAL FIELD

The present invention relates to an optical rotator (hereinafter referred to as “wavelength selective optical rotator”) which is used in optical systems for optical storage, optical communication, optical imaging, etc. and has such wavelength selectivity as to convert incident linearly polarized light into exit linearly polarized light that is polarized in a different direction than the incident light.

### BACKGROUND ART

Consideration will be given to an optical head device as an example optical system for optical storage which writes information on and reads information from an optical recording medium such as a CD, a DVD, or a magneto-optical disc or a high-density optical recording medium such as a BD or an HD DVD (hereinafter referred to as “optical disc”). In the optical head device, exit light emitted from a semiconductor laser is focused on an optical recording medium by a lens and the focused exit light is reflected by the optical recording medium to become return light. The exit light as the return light is guided to a photodetecting element by a beam splitter, whereby information on the optical recording medium is converted into an electrical signal.

In the optical head device, the light utilization efficiency and the writing and reading performance can be enhanced by controlling the polarization state such as the polarization plane of light emitted from the semiconductor laser using such elements as a half-wave plate, a quarter-wave plate, and a polarizing beam splitter. In doing so, a half-wave plate or an optical rotator, for example, is used as an optical element having a function of receiving light having a particular wavelength and outputting light that is perpendicular in polarization state to the incident light.

The half-wave plate is realized by selecting a birefringent material used and adjusting its thickness so as to have a retardation value (2m+1)λ/2, for example, for incident light having a particular wavelength λ (m is an integer) . The thus-configured half-wave plate outputs light that is perpendicular in polarization state to incident light.

Among optical rotators which rotates incident linearly polarized light into linearly polarized light that is polarized in a desired direction is a twist-type liquid crystal element (hereinafter referred to as “liquid crystal optical rotator”) in which liquid crystal molecules are oriented so as to be twisted along the light traveling direction. A quartz optical rotator using quartz is reported as a non-liquid crystal optical rotator (Non-patent document 1).

Non-patent document 1: Tadao Tsuruta: “Applied Physical Optics II,” Baifukan, Jul. 20, 1990, p. 167.

### DISCLOSURE OF THE INVENTION

Problem that the Invention is to Solve

However, it is difficult for the half-wave plate, liquid crystal optical rotator, and quartz optical rotator to perform such control as to convert incident linearly polarized light beams that are polarized in the same direction and have different wavelengths into exit light beams having particular polarization states . In particular, when it is necessary to convert incident linearly polarized light having a particular wavelength into exit light that is perpendicular in polarization direction to the incident light and to output incident linearly polarized light having another, different particular wavelength without changing its polarization state, combinations of such wavelengths are restricted. The degree of freedom of designing is thus made low.

In each of the half-wave plate and the liquid crystal optical rotator, to convert linearly polarized light that is incident on the optical element into exit light having a desired polarization state, the incident light should have a particular polarization direction. For example, in the case of a half-wave plate made of a birefringent material, to obtain linearly polarized light that is perpendicular in polarization direction to incident linearly polarized light, the polarization direction of the incident light should be set so as to form 45° with the optic axis of the half-wave plate. In the case of the liquid crystal optical rotator, there is a restriction that the alignment direction of liquid crystal molecules at the light-incidence-side boundary of the liquid crystal layer should be set so as to coincide with the polarization direction of incident linearly polarized light.

Unlike in the above cases, the quartz optical rotator disclosed in Non-patent document 1 can produce exit light that is perpendicular in polarization state to linearly polarized incident light irrespective of the incident light. However, although as described above the quartz optical rotator can produce exit light that is perpendicular to incident light having a particular wavelength, the angle (hereinafter referred to as “rotation angle”) by which exit light is rotated from that of incident light varies depending on the wavelength. FIG. 9 shows wavelength dependence of the rotation angle that were obtained by inputting linearly polarized light beams having various wavelengths into a quartz optical rotator that was designed so as to convert incident linearly polarized light having a wavelength 405 nm into exit light that is perpendicular in polarization direction to the incident light (the rotation angle is 90°.

As seen from FIG. 9, whereas the rotation angle is 90° at 405 nm, the rotation angle decreases gradually as the wavelength of incident light increases starting from 405 nm and the rotation angle becomes about 20° at 800 nm. Therefore, when light whose wavelength is longer than 405 nm is incident, exit light is not perpendicular to the incident light and a non-zero rotation angle is obtained. Having a millimeter-order thickness, the quartz optical rotator has problems that it is disadvantageous in the space occupied by the optical element and the cost is high. As such, the above-described optical elements suffer many restrictions in realizing the function of converting light beams having different wavelengths into exit light beams having desired polarization states, and cannot realize that function easily. That is, the half-wave plate and the liquid crystal optical rotator also suffer many restrictions in controlling the polarization states of exit light beams for incident light beams having different wavelengths.

### Means for Solving the Problem

To solve the above problems, the invention has an object of realizing wavelength selective optical rotator which can convert incident linearly polarized light beams having different wavelengths into exit linearly polarized light beams while setting the rotation angle freely for each wavelength and which can reduce the thickness of a device including it.

The invention provides a wavelength selective optical rotator including a liquid crystal layer including a cholesteric-phase liquid crystal, wherein: when a first linearly polarized light having a wavelength λ₁ is incident on the liquid crystal layer, the liquid crystal layer converts the first linearly polarized light into a second linearly polarized light is a different linearly polarized light from the first linearly polarized light and outputs the latter; and when a linearly polarized light having a wavelength λ₂ that is longer than the wavelength λ₁ is incident on the liquid crystal layer, the liquid crystal layer outputs the linearly polarized light without changing its polarization state substantially.

The invention provides a wavelength selective optical rotator according to the above, wherein the first and second linearly polarized lights are approximately perpendicular to each other or form approximately 45°.

With this configuration, a wavelength selective optical rotator can be realized which converts incident light having a particular wavelength into exit light whose polarization state is rotated by a desired angle and converts incident light having a different wavelength into exit light whose polarization state is not rotated and polarization state is kept unchanged.

The invention provides a wavelength selective optical rotator according to claims 1 and 2, wherein the cholesteric-phase liquid crystal has a reflection band for one of incident clockwise circularly polarized light and counterclockwise circularly polarized light; and the wavelength λ₁ is located on the shorter wavelength side of the reflection band and the wavelength λ₂ is located on the longer wavelength side of the reflection band. Further, when the first linearly polarized light having a wavelength λ₄ that is different from the wavelengths λ₁ and λ₂ (λ₁<λ₄<λ₂) and is located on the longer wavelength side of the reflection band is incident on the liquid crystal layer, the liquid crystal layer converts it into the second linearly polarized light and outputs the latter.

The invention provides a wavelength selective optical rotator according to the above, wherein in the above wavelength selective optical rotator, the cholesteric-phase liquid crystal has a reflection band for one of incident clockwise circularly polarized light and counterclockwise circularly polarized light; and the wavelengths λ and λ₂ are both located on the longer wavelength side of the reflection band.

With this configuration, utilizing the fact that in the cholesteric-phase liquid crystal the wavelength dependence of the refractive index for incident clockwise circularly polarized light is different from that for incident counterclockwise circularly polarized light, a wavelength selective optical rotator can be realized which has a function of convert incident light having a particular wavelength into exit light whose polarization direction is rotated by a prescribed angle.

The invention provides a wavelength selective optical rotator, wherein, in the above wavelength selective optical rotator, a selective reflection wavelength of the cholesteric-phase liquid crystal is located at one point in a range of 300 to 610 nm.

With this configuration, since the wavelengths λ₁ and λ₂ can be set in a wide range, a wavelength selective optical rotator can be realized in which the degree of freedom in combining those wavelengths is high.

The invention provides a wavelength selective optical rotator, wherein, in the above wavelength selective optical rotator, when linearly polarized light having a wavelength λ₃ that is different from the wavelengths λ₁ and λ₂ (λ₃>λ₂) is incident on the liquid crystal layer, the liquid crystal layer outputs it without changing its polarization state substantially.

With this configuration, a wavelength selective optical rotator can be realized which can output only the linearly polarized light having the wavelength λ₁ while changing the polarization state among the linearly polarized light beams having the three different wavelengths λ₁, λ₂, and λ₃.

The invention provides a wavelength selective optical rotator which is configured in such a manner that two or more wavelength selective optical rotators, which are the same as at least one of the wavelength selective optical rotators according to the above, are laid on each other.

With this configuration, a wavelength selective optical rotator can be realized which can convert incident light beams having two or more different wavelengths, in particular, three or more different wavelengths, into exit light beams whose polarization directions are rotated by desired angles, respectively, and which can thus be designed with a high degree of freedom.

The invention provides an optical head device comprising at least one light source for emitting the first linearly polarized lights having at least the wavelengths λ₁ and λ₂; a beam splitter for deflection-separating the light beams emitted from the light source; objective lenses for focusing light beams that are output from the beam splitter on optical recording media, respectively; a photodetector for detecting light beams reflected from the respective optical recording media; and the above-described wavelength selective optical rotator which is disposed in an optical path between the light source and the beam splitter.

With this configuration, an optical system can be realized which can easily deflection-separate light beams having the wavelengths λ₁ and λ₂. This provides an advantage that the degree of freedom of designing of the optical system of an optical head device is increased.

The invention provides an optical head device, wherein, in the above optical head device, at least one light source for emitting the first linearly polarized lights having the wavelengths λ₁, λ₂, and λ₃, respectively, is provided; and the wavelengths λ₁, λ₂, and λ₃ are in a 405-nm wavelength band, a 660-nm wavelength band, and a 785-nm wavelength band, respectively.

With this configuration, an optical system can be realized which can easily deflection-separate light having the wavelength λ₁ (light for a BD) , and light having the wavelength λ² (light for a DVD) , and light having the wavelength λ₃ (light for a CD) . This provides an advantage that the degree of freedom of designing of the optical system of an optical head device is increased. For example, where an optical element is used which transmits light having one wavelength without changing its polarization state and converts light having another, different wavelength into exit light that is perpendicular in polarization state to the incident light, light beams can be deflection-separated by such an element as a polarizing beam splitter according to the wavelengths of incident light beams and the degree of freedom of designing of the optical system is thus increased. The optical element for the deflection separating is not limited to a polarizing beam splitter such as a prism and may be a diffraction element which transmits or diffracts incident light depending on its polarization state.

### Advantage of the Invention

The invention can provide a highly controllable wavelength selective optical rotator which can not only convert linearly polarized light having a particular wavelength into exit light whose polarization state is rotated by a prescribed angle but also convert each of linearly polarized light beams having different wavelengths into exit light with its rotation angle controlled or without changing its polarization state.

### BRIEF DESCRIPTION OF THE DRAWINGS

FIG. 1 is a schematic sectional view of a wavelength selective optical rotator according to the present invention.

FIG. 2 shows the wavelength dependence of the refractive index of a cholesteric-phase liquid crystal layer used in a first embodiment.

FIGS. 3A and 3B show an optical system in which the rotation angle of the wavelength selective optical rotator is approximately equal to 90°.

FIGS. 4A to 4D show optical systems in which the rotation angle of the wavelength selective optical rotator is approximately equal to 45°.

FIG. 5 shows the wavelength dependence of the refractive index of a cholesteric-phase liquid crystal layer used in a second embodiment.

FIG. 6 shows the wavelength dependence of the refractive index of a cholesteric-phase liquid crystal layer used in a third embodiment.

FIG. 7 is a schematic diagram of an optical head device.

FIG. 8 shows incident light wavelength dependence of the rotation angle.

FIG. 9 shows the incident light wavelength dependence of the rotation angle of a conventional quartz optical rotator.

### DESCRIPTION OF SYMBOLS

10: Wavelength selective optical rotator
11a, 11b: Transparent substrate
12a, 12b: Alignment film
13: Cholesteric-phase liquid crystal layer
16, 23: Polarizing beam splitter
17, 25a, 26b: Quarter-wave plate
18: Liquid crystal element
18a: Liquid crystal molecules
19: Voltage control device
20: Optical head device
21: Light source
22: Collimator lens
24: Mirror
26a, 26b: Objective lens
27: High-density optical recording medium
27b: DVD/CD
28: Photodetector
31a: Optical path (outward path) for 405-nm wavelength band
31b: Optical path (return path) for 405-nm wavelength band
32a: Optical path (outward path) for 660/785-nm wavelength band
32b: Optical path (return path) for 660/785-nm wavelength band

### BEST MODE FOR IMPLEMENTING THE INVENTION

### First Embodiment

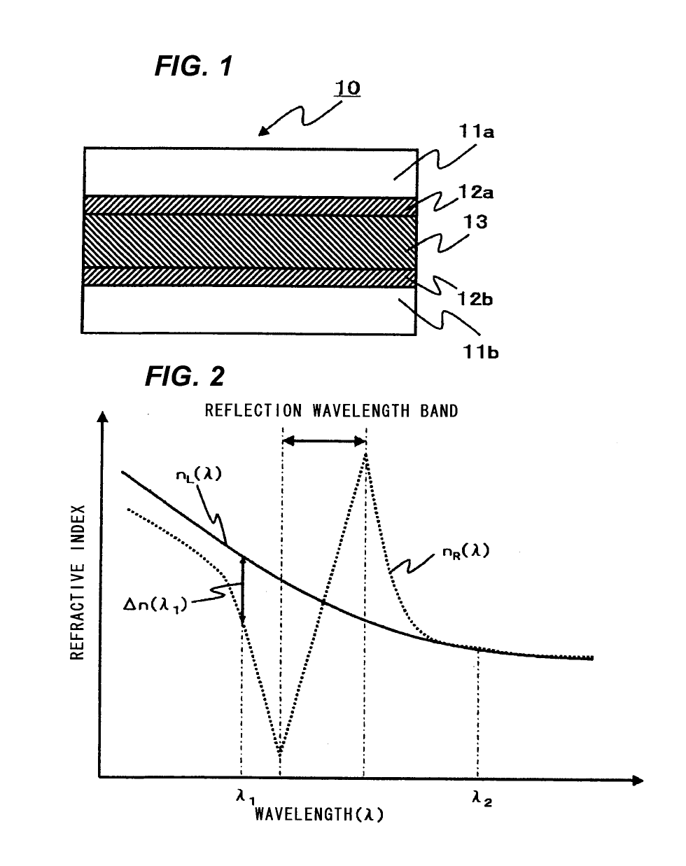

FIG. 1 conceptually shows the structure of a wavelength selective optical rotator 10 according to this embodiment. As shown in FIG. 1, the wavelength selective optical rotator 10 uses, as a birefringent material, a cholesteric-phase polymeric liquid crystal layer 13 obtained by polymerizing a cholesteric-phase liquid crystal that consists of a liquid crystal having polymerizable portions and a chiral agent. As shown in FIG. 1, alignment films 12a and 12b are formed by applying polyimide films to the respective transparent substrates 11a and 11b, firing them, and rubbing resulting films. The transparent substrates 11a and 11b are laid on each other so that the alignment films 12a and 12b are opposed to each other, and a cholesteric-phase liquid crystal monomer having polymerizable portions is injected into the space between the alignment films 12a and 12b and polymerized and solidified into the cholesteric-phase polymeric liquid crystal layer 13 by exposure with ultraviolet light. In doing so, the cholesteric-phase polymeric liquid crystal layer 13 is held at a desired thickness by dispersing spherical or cylindrical spacers (not shown) between the alignment films 12a and 12b. Even if not polymerized or solidified, the cholesteric-phase liquid crystal provides the same effect as long as the spiral axis of liquid crystal molecules is parallel with the thickness direction and liquid crystal molecules are oriented spirally at a constant pitch. However, polymerizing and solidifying the cholesteric-phase liquid crystal is preferable because it increases the reliability and improves the temperature characteristic.

The transparent substrates are made of glass or plastics. The use of glass is preferable in terms of the resistance to light and heat. The alignment films may be formed by obliquely evaporating SiO₂ or the like instead of rubbing polyimide films. To reduce the loss of incident light, it is preferable to form antireflection films on the surfaces of the transparent substrates.

Where the wavelength λ of incident light is approximately equal to the product of the spiral pitch P and the refractive index n of the cholesteric-phase liquid crystal, the cholesteric-phase liquid crystal has circular polarization dependence that, among light beams that are incident parallel with the spiral axis, most of circularly polarized light whose rotation direction is the same as the twist direction of liquid crystal molecules is reflected and most of circularly polarized light having the opposite rotation direction is transmitted. The center frequency λ₀ (hereinafter referred to as “selective reflection wavelength”) of a wavelength range where the above reflection occurs is given by Equation (1) , where P is the spiral pitch, nₒ is the ordinary refractive index, and nₑ is the extraordinary refractive index. The reflection bandwidth AX is given by Equation (2). A reflection wavelength band is defined as (λ₀±Δλ/2).

### [Formulae 1]

λ₀=(nₒ+nₑ)·P/2 . . . (1)

Δλ=(nₑ−nₒ)·P . . . (2)

From the above discussion, it can be said that the cholesteric-phase polymeric liquid crystal layer 13 functions as a reflection layer if light in the reflection wavelength band travels parallel with the spiral axis direction of liquid crystal molecules and is circularly polarized with the polarization direction rotating in the same direction as the twist direction of liquid crystal molecules. The reflectance in the reflection wavelength band depends on the number of spiral pitches in the cholesteric-phase polymeric liquid crystal layer 13. The number of spiral pitches is represented by the number of rotations of liquid crystal molecules. Where the number of spiral pitches is larger than 10, high reflectance is obtained almost uniformly in the reflection wavelength band without depending on the layer thickness.

FIG. 2 conceptually shows the wavelength dependence of the refractive index of the cholesteric-phase polymeric liquid crystal layer 13. The twist direction of liquid crystal molecules of the cholesteric-phase polymeric liquid crystal layer 13 may be either clockwise or counterclockwise toward the light traveling destination side. The following description will be directed to an example case that the twist direction of liquid crystal molecules of the cholesteric-phase polymeric liquid crystal layer 13 is clockwise toward the light traveling destination side. In this case, when clockwise circularly polarized light is incident, a large refractive index variation occurs in the reflection wavelength band and its vicinities.

On the other hand, for counterclockwise circularly polarized light, no large refractive index variation occurs because there is no reflection wavelength band. The refractive index anisotropy Δn(λ) for circularly polarized light is given by |n_{R}(λ) −n_{L}(λ)|, where n_{R}(λ) is the refractive index for clockwise circularly polarized light having a wavelength λ, and n_{L}(λ) is the refractive index for counterclockwise circularly polarized light having the wavelength λ.

The parameter Δn is not zero in the reflection wavelength band and its vicinities. When light whose wavelength is much different from the reflection wavelength band is incident, it is subjected to Δn that is much smaller than for light whose wavelength is in the reflection wavelength band or its vicinities. When light having such a wavelength as to make Δn approximately equal to zero, no refractive index anisotropy for circularly polarized light occurs. The reflection wavelength band can be controlled by adjusting the spiral pitch P in the above-described manner. That is, the cholesteric-phase liquid crystal is formed by adding a chiral agent to a nematic liquid crystal or a nematic liquid crystal having asymmetric carbon atoms, and the reflection wavelength band can be determined by adjusting the content of the chiral agent.

Since as described above circularly polarized light whose polarization direction rotates in the same direction as the twist direction of liquid crystal molecules is reflected and is very low in transmittance in the reflection wavelength band (see FIG. 2), circularly polarized light whose polarization direction rotates in the direction opposite to the twist direction mainly passes through the cholesteric-phase liquid crystal. Therefore, if linearly polarized light whose wavelength is in the reflection wavelength band is incident, circularly polarized light rather than linearly polarized light is output with as low transmittance as about 50%. Therefore, the function of an optical rotator cannot be obtained if the wavelength of incident light is within the reflection wavelength band. The reflection wavelength band should be set so as not to include the wavelength of incident light by adjusting the content of the chiral agent.

Setting a reflection wavelength band and inputting light beams whose wavelengths are outside the reflection wavelength band in the above-described manner (see FIG. 2) make it possible to adjust An values at those respective wavelengths. In the embodiment, two wavelength λ₁ and λ₂ (λ¹<λ₂) are set on the shorter wavelength side and the longer wavelength side, respectively, of the reflection wavelength band. In particular, the wavelength λ₁ is set so as to satisfy Δn>0 and the wavelength λ₂ is set so as to satisfy οn≅0. Equation (3) holds in which Δn(λ₁) is An at λ₁ and d is the thickness of a cholesteric-phase liquid crystal layer. Character m is an integer.

### [Formula 2]

Δn(λ₁)·d=(2m+1)·λ₁/2 . . . (3)

A retardation for light having a wavelength X is defined as the product Δn(λ)·d as found in Equation (3). If the retardation is set so as to satisfy Equation (3), when linearly polarized light having a wavelength λ₁ is incident, linearly polarized light that is perpendicular in polarization state to the incident light is output. On the other hand, light having a wavelength λ₂ causes no retardation, the polarization state of exit light is the same as that of incident light. Equation (3) shows the retardation condition for making the polarization states of incident light and exit light approximately perpendicular to each other. Light whose polarization state is rotated by an arbitrary rotation angle can be output by adjusting the thickness d. It is assumed here that linearly polarized light is incident whose polarization state is such that the electric vector oscillates in the same direction even if its wavelength is varied. This polarization state is referred to as a first polarization state. The following description will be made with an assumption that a polarization state of exit light that is different from the first polarization state is referred to as a second polarization state.

Whereas the above example employs the design condition that the first polarization state is approximately perpendicular to the second polarization state, another design condition is possible that the directions of the first polarization state and the second polarization state form an angle of about 45°. In this manner, a wavelength selective optical rotator can be realized which can provide optical rotatory power at a particular wavelength and enables setting of an arbitrary rotation angle. The term “approximately perpendicular” means that the angle formed by the polarization directions of incident light and exit light is in the range of 90°±10°. The expression “the polarization state is not changed substantially (the polarization directions are approximately parallel with each other)” means that the polarization direction of exit light is within ±10° of that of incident light. The term “about 45° ” means the range of 45°±10°.

To stabilize the optical characteristics, it is preferable that the wavelength λ₁ be set at a wavelength that is spaced from the reflection wavelength band and its vicinities so as not to cause a large variation in the refractive index anisotropy Δn(λ₁) for circularly polarized light when the wavelength λ₁ of incident light fluctuates and that can keep the rotation angle approximately constant for a wavelength variation. A variation of ±10% or less of Δn(λ₁)/λ₁ for a ±3% fluctuation of the wavelength λ₁ is preferable because the wavelength-dependent variation of the rotation angle is kept within 10%, though this depends on the optical system.

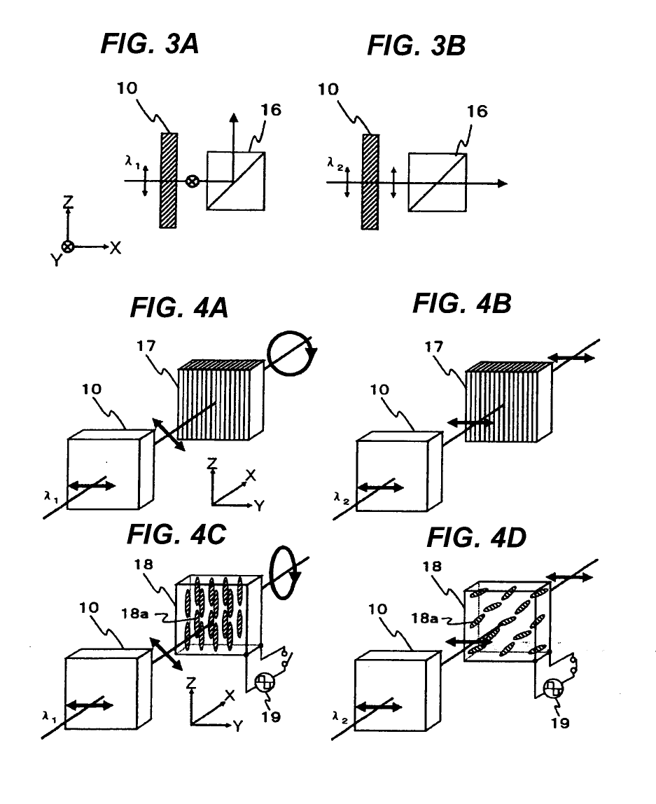

A description will be made of a use example of the wavelength selective optical rotator capable of producing exit light beams having different polarization states when light beams having wavelengths λ₁ and λ₂ are incident. First, consideration will be given to a case that the wavelength selective optical rotator has a function of outputting exit light that is perpendicular to incident light having a wavelength λ₁ when receiving that incident light and outputting exit light having substantially the same polarization state as incident light having a wavelength λ₂ when receiving that incident light. FIGS. 3A and 3B show an optical system in which a polarizing beam splitter 16 is disposed on the light exit side of the wavelength selective optical rotator 10. As shown in FIG. 3A, light having the wavelength λ₁ that is output from the wavelength selective optical rotator 10 with a rotation angle of about 90°, which is linearly polarized light whose electric vector oscillates in the Y-axis direction, is deflected by the polarizing beam splitter so as to travel in the Z-axis direction. On the other hand, as shown in FIG. 3B, light having the wavelength λ₂ that is output from the wavelength selective optical rotator 10 with substantially no change in polarization state, which is linearly polarized light whose electric vector oscillates in the Z-axis direction, passes through the polarizing beam splitter 16 straight in the X-axis direction. In this manner, the deflection state of incident light can be changed depending on its wavelength, which increases the degree of freedom of designing of the optical system. The polarizing beam splitter is not limited to the above one and may be a polarizing diffraction element.

Next, a description will be made of an example optical system in which the wavelength selective optical rotator converts incident light having a wavelength λ₁ into exit light whose polarization direction is rotated by an angle that is not equal to about 90°. FIGS. 4A and 4B are schematic diagrams of an optical system in which a quarter-wave plate 17 having optic axes in the Z-axis direction and the Y-axis direction is disposed on the light exit side of the wavelength selective optical rotator 10. As shown in FIG. 4A, light having a wavelength λ₁ is output from the wavelength selective optical rotator 10 with a rotation angle of about 45°. Since the electric vector of the linearly polarized light that is incident on the quarter-wave plate 17 oscillates in a direction that forms about 45° with the optic axes of the quarter-wave plate 17, circularly polarized light is output from the quarter-wave plate 17. On the other hand, as shown in FIG. 4B, exit light having substantially the same polarization direction as incident light having a wavelength λ₂ is output from the wavelength selective optical rotator 10. Since the electric vector oscillation direction of the linearly polarized light incident on the quarter-wave plate 17 is parallel with one of the optic axes of the quarter-wave plate 17, exit light is output with no change in polarization direction. In this manner, circularly polarized light or linearly polarized light is produced depending on the wavelength, where by the degree of freedom of designing of the optical system is increased. The wave plate is not limited to the quarter-wave plate and can be designed so as to produce desired polarization states.

The optical system using the wavelength selective optical rotator is not limited to the above one.

FIG. 4C and FIG. 4D are schematic diagrams of an optical system in which a liquid crystal element 18 capable of modulating the optical path length of light that is polarized in the Z-axis direction when the application voltage is controlled by a voltage control device 19 is disposed on the light exit side of the wavelength selective optical rotator 10. FIG. 4C shows how the polarization direction of light having a wavelength λ₁ is rotated by about 45° by the wavelength selective optical rotator. FIG. 4D shows how light having a wavelength λ₂ is output from the wavelength selective optical rotator with substantially no change in polarization state. Transparent electrodes (not shown) made of ITO or the like are formed on the light incidence surface and exit surface of the liquid crystal element 18 and alignment films (not shown) for controlling the orientation of the liquid crystal when no voltage is applied to it are also formed on those surfaces. When no voltage is applied to the liquid crystal element 18, the longer axes of liquid crystal molecules 18a are oriented uniformly parallel with the Z-axis direction. In the liquid crystal element 18, for example, as shown in FIG. 4C, the longer axes of liquid crystal molecules 18a are inclined in the Z-X plane according to the magnitude of the voltage that is applied to the liquid crystal 18 in the X-axis direction by the voltage control device 19. In this manner, the optical path length can be modulated for light that is polarized in the Z-axis direction.

The optical path length of light that is polarized in the Y-axis direction is not modulated by voltage application. As shown in FIG. 4C, since the polarization direction of light having a wavelength X that is output from the wavelength selective optical rotator 10 forms about 45° with the optic axes of the liquid crystal element 18, the liquid crystal element 18 functions as a wave plate. Light that is output from the liquid crystal element 18 can be given a desired polarization state such as circular polarization, or elliptical polarization by controlling, according to the magnitude of the voltage applied to the liquid crystal element 18, the difference between the optical path length, in the liquid crystal element 18, of light that is polarized in the Z-axis direction and the optical path length of light that is polarized in the Y-axis direction.

On the other hand, as shown in FIG. 4D, light having a wavelength λ₂ is output from the wavelength selective optical rotator 10 with substantially no change in polarization state. The polarization direction of the light having the wavelength λ₂ that is output from the wavelength selective optical rotator 10 is parallel with one of the optic axes of the liquid crystal element 18, and hence is output from the liquid crystal element 18 with its polarization state unchanged irrespective of the magnitude of the application voltage. In this manner, the polarization state can be controlled according to the magnitude of the voltage applied to the liquid crystal element 18, depending on the wavelength. Although the above description has been made with the assumption that the rotation angle of the wavelength selective optical rotator 10 is equal to 45°, it may be 90° or some other angle. The polarization state of light entering the liquid crystal element 18 may be changed in such a manner that its polarization direction is made different from the longer-axis direction and the shorter-axis direction of liquid crystal molecules 18a. Alternatively, it is possible to change the polarization state of light having the wavelength λ₂ while keeping the polarization state of light having the wavelength λ₁unchanged.

Furthermore, the phase of light that is output from the liquid crystal element 18 can be modulated according to the magnitude of the application voltage by setting the polarization direction of light entering the liquid crystal element 18 the same as the longer-axis direction of liquid crystal molecules 18a. For example, if settings are made so that light having a wavelength λ₁ that is output from the wavelength selective optical rotator 10 is polarized in the Z-axis direction and light having a wavelength λ₂ that is output from the wavelength selective optical rotator 10 is polarized in the Y-axis direction, the phase of the light having the wavelength λ₁ can be modulated according to the application voltage and the phase of the light having the wavelength λ₂ can be kept unchanged irrespective of the magnitude of the application voltage. Still further, the wave front shape of light having a wavelength λ₁ can be controlled by forming a desired phase distribution in the Y-Z plane in the liquid crystal element 18. One method for forming such a phase distribution is to form a voltage distribution by dividing an ITO electrode or the like (not shown). As described above, the phase or the wave front shape can be controlled according to the magnitude of the application voltage depending on the wavelength. Alternatively, it is possible to change the phase or the wave front shape of light having the wavelength λ₂ while keeping the phase or the wave front shape of light having the wavelength λ₁ unchanged.

### Second Embodiment

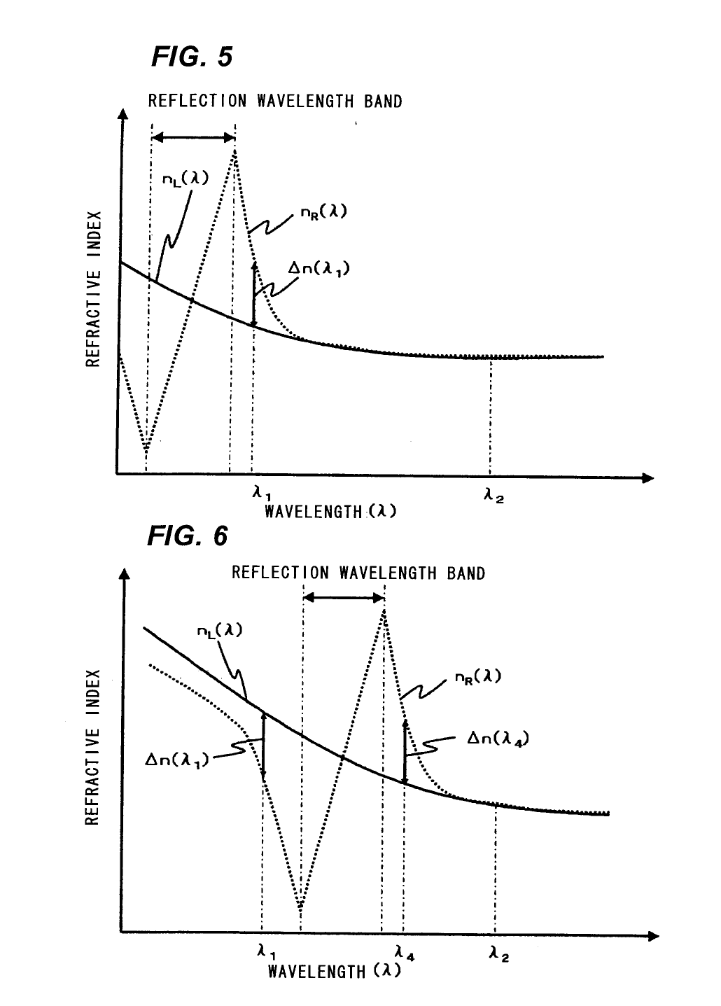

In this embodiment, the structure of the wavelength selective optical rotator 10 is the same as in the first embodiment and the reflection wavelength band is set on the shorter wavelength side of the wavelength λ₁ by adjusting the pitch P of the cholesteric-phase liquid crystal. FIG. 5 is a conceptual diagram showing wavelength dependence of the refractive index, in which the wavelength λ₁ is located on the longer wavelength side of the reflection wavelength band and Δn(λ₁) has a non-zero value. The rotation angle can be determined by adjusting, for the wavelength λ₁, the retardation which is the product of the refractive index anisotropy Δn(λ₁) and the thickness of the cholesteric-phase liquid crystal layer. Light that is perpendicular in polarization state to incident linearly polarized light can be output by a design that satisfies the above-described Equation (3).

Although the above descriptions have been directed to the case of dealing with incident light beams having different wavelength λ₁ and λ₂, the reflection wavelength band and the thickness of the cholesteric-phase liquid crystal layer can be set so that desired rotation angles can be realized at three or more different wavelengths, respectively.

### Third Embodiment

In this embodiment, the structure of the wavelength selective optical rotator 10 is the same as in the first embodiment and the reflection wavelength band is set between the wavelengths λ₁ and λ₂ by adjusting the pitch P of the cholesteric-phase liquid crystal. If non-zero refractive index anisotropy Δn(λ₄) for circularly polarized light at a wavelength λ₄ that is between the wavelengths λ₁ and λ₂ (λ₁<λ₄<λ₂) is attained as shown in FIG. 6, a wavelength selective optical rotator can be realized having such characteristics as to provide desired rotation angles at the two different wavelengths λ₁ and λ₄.

Furthermore, for example, a configuration is possible in which settings are made so that the wavelength selective optical rotator gives rotation angles −45°, +45°, and 0° to incident linearly polarized light beams that are polarized in the same direction and having the wavelengths λ₁, λ₄, and λ₂, respectively, and a wideband quarter-wave plate that performs the quarter-wave plate function on light at least in the wavelength range of λ₁ to λ₂ is disposed on the light exit side of the wavelength selective optical rotator or laid on the light-exit-side surface of the wavelength selective optical rotator. With this combination, the polarization states can be controlled so that light having the wavelength λ₁ is given circular polarization, light having the wavelength λ₄ is given circular polarization and light having the wavelength λ₂ is given linear polarization, and the polarization states can be also controlled so that light having the wavelength λ₁ is given linear polarization, light having the wavelength λ₄ is given linear polarization and light having the wavelength λ₂ is given circular polarization. The optical element to be provided on the light exit side of the wavelength selective optical rotator is not limited to the wideband quarter-wave plate and may be any of optical elements having various functions. In this manner, polarization states can be designed with a high degree of freedom.

### Fourth Embodiment

In the first to third embodiments, the wavelength selective optical rotator 10 is such as to provide desired rotation angles for light beams having respective wavelengths using one cholesteric-phase (polymeric) liquid crystal layer. Alternatively, for example, two or more cholesteric-phase (polymeric) liquid crystal layers having different optical rotatory power may be disposed in the optical path. This enables designing with a higher degree of freedom. Although not shown in any drawings, the wavelength selective optical rotator used in this embodiment may have, for example, a structure that two or more cholesteric-phase (polymeric) liquid crystal layers are formed on both sides of a single transparent substrate.

One example wavelength selective optical rotator including two or more cholesteric-phase liquid crystal layers is such that a layer having the characteristic of FIG. 5 (second embodiment) is used as a first cholesteric-phase liquid crystal layer and a layer having the characteristic of FIG. 6 (third embodiment) is used as a second cholesteric-phase liquid crystal layer. If the first cholesteric-phase liquid crystal layer and the second cholesteric-phase liquid crystal layer have the same refractive index anisotropy Δn(λ₁) for circularly polarized light at the wavelength λ₁, when light having the wavelength λ₁ passes through the wavelength selective optical rotator, its polarization direction is rotated in the opposite directions by the first cholesteric-phase liquid crystal layer and the second cholesteric-phase liquid crystal layer, that is, the rotation angles cancel out each other. As a result, the linearly polarized light entering the wavelength selective optical rotator is output from it with no change in polarization state.

On the other hand, the refractive index anisotropy Δn(λ₄) for circularly polarized light at the wavelength λ₄ (λ₁<λ₄<λ₂) is approximately equal to zero, i.e. the polarization direction is not rotated, in the first cholesteric-phase liquid crystal layer. The rotation angle can be adjusted only by the second cholesteric-phase liquid crystal layer. The refractive index anisotropy Δn(λ₂) for circularly polarized light at the wavelength λ² is approximately equal to zero in each of the first cholesteric-phase liquid crystal layer and the second cholesteric-phase liquid crystal layer. Therefore, the linearly polarized light entering the wavelength selective optical rotator is output from it with no change in polarization state. In this manner, for example, the use of the wavelength selective optical rotator including two cholesteric-phase liquid crystal layers having different characteristics enables such a design that a particular rotation angle is given to only light having the wavelength λ₄. It is possible to provide a wavelength selective optical rotator including three or more cholesteric-phase liquid crystal layers. The combination of two or more cholesteric-phase liquid crystal layers is not limited to combinations of cholesteric-phase liquid crystal layers in which the twist direction of liquid crystal molecules is only clockwise or counterclockwise toward the light traveling destination side, and may be combinations including cholesteric-phase liquid crystal layers in which the twist direction of liquid crystal molecules is clockwise and counterclockwise, respectively. Furthermore, cholesteric-phase liquid crystal layers having the same wavelength dependence of the reflective index anisotropy for circularly polarized light may be used.

### Embodiment of Optical Head Device

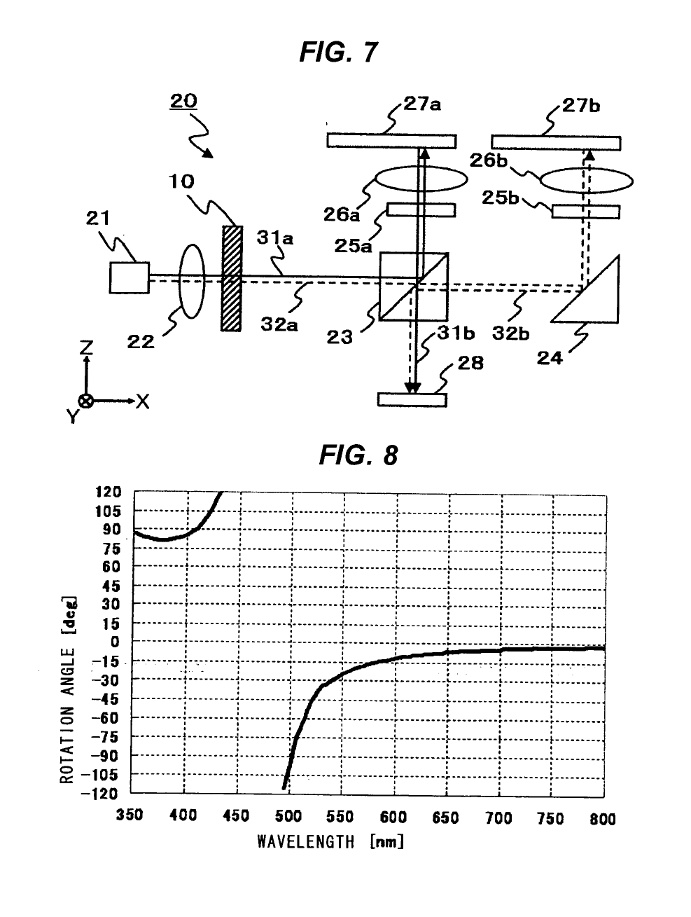

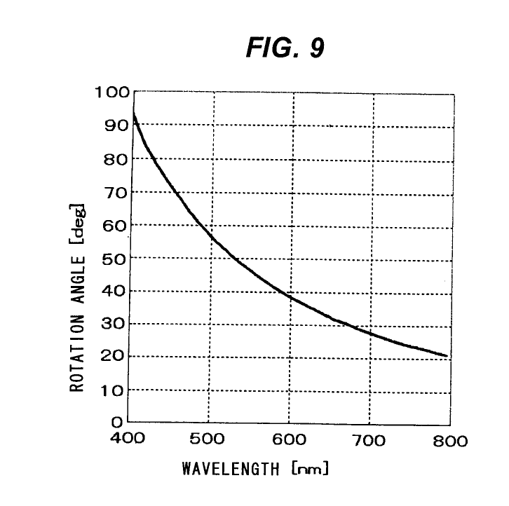

This embodiment is directed to an optical head device which is equipped with the wavelength selective optical rotator. FIG. 7 is a schematic diagram of the optical head device. The optical head device 20 is configured so as to be able to write and read data on and from a Blu-ray disc (registered trademark) or an HD DVD, a DVD, and a CD. Laser light in a 405-nm wavelength band (385 to 420 nm) is used for high-density optical recording media (Blu-raydiscs or HD DVDs) , laser light in a 660-nm wavelength band (640 to 675 nm) is use for DVDs, and laser light in a 785-nm band (770 to 800 nm) is used for CDs.

If the optical head device 20 is configured in such a manner that a single polarizing beam splitter, a single quarter-wave plate, and a single objective lens are used for laser beams having the above three different wavelengths, it is expected that the number of components is decreased. However, it is difficult to control the polarization states or realize high light utilization efficiency for all laser beams in a wide band covering the above wavelength bands. On the other hand, although providing a set of a polarizing beam splitter, a quarter-wave plate, and an objective lens for each of the three wavelengths enables the control of the polarization states and attains high light utilization efficiency, such a device is hard to miniaturize because of a large number of components. In this embodiment, as described later, three laser beams are separated so as to take two optical paths, whereby miniaturization and the control of the polarization states are enabled and high light utilization efficiency can be attained. If all light beams having the above three different wavelengths take the same optical path and share an objective lens, an effective focusing characteristic can not be obtained for all of those light beams. One promising optical system is such that an objective lens is provided in an optical path for the 405-nm wavelength band and an objective lens is provided in an optical path for both of the 660-nm wavelength band and the 785-nm wavelength band.

A light source 21 maybe configured so as to emit linearly polarized light beams having two or three wavelengths. Examples of the light source 21 having such a configuration are a what is called hybrid two-wavelength or three-wavelength laser light source in which two or three semiconductor laser chips are mounted on the same substrate and a monolithic two-wavelength or three-wavelength laser light source having two or three light emitting points that emit light beams having different wavelengths. The following description will be made with an assumption that each of light beams emitted from the light source travels in the X-axis direction and is linearly polarized light whose electric vector oscillates in the Z-axis direction.

Light emitted from the light source 21 is converted into parallel light by a collimator lens 22 and enters the wavelength selective optical rotator 10. The wavelength selective optical rotator 10 has such characteristics as to rotate the polarization direction of light in the 405-nm wavelength band by about 90° and does not rotate the polarization direction of light in the 660-nm wavelength band and the polarization direction of light in the 785-nm wavelength band (the rotation angle is approximately equal to 0°). That is, in the characteristics of the wavelength selective optical rotator shown in FIGS. 2 (first embodiment) and 5 (second embodiment), λ₁, λ₂, and λ₃ (not shown; >λ₂) are set at 405 nm, 660 nm, and 785 nm, respectively. In the optical head device 20, the optical path for the light in the 405-nm wavelength band is indicated by a solid line. The optical path from the light source 21 to a high-density optical recording medium 27a is an outward path 31a, and the optical path from the high-density optical recording medium 27a to a photodetector 28 is a return path 31b. The optical path for each of the light in the 660-nm wavelength band and the light in the 785-nm wavelength band is indicated by a broken line. The optical path from the light source 21 to a DVD/CD 27b is an outward path 32a, and the optical path from the DVD/CD 27b to the photodetector 28 is a return path 32b.

The polarization direction of the light in the 405-nm wavelength band whose electric vector oscillates in the Z-axis direction is rotated by 90° by the wavelength selective optical rotator 10 and becomes linearly polarized light whose electric vector oscillates in the Y-axis direction, which enters a polarizing beam splitter 23. The polarizing beam splitter deflects the light whose electric vector oscillates in the Y-axis direction toward the high-density optical recording medium 27a so that it passes through a quarter-wave plate 25a and an objective lens 26a and is focused on the information recording surface of the high-density optical recording medium 27a. In the return path 31b, reflected light passes through the objective lens 26a and the quarter-wave plate 25a and becomes linearly polarized light whose electric vector oscillates in the X-axis direction, which passes straight through the polarizing beam splitter 23 and reaches the photodetector 28.

On the other hand, each of the light in the 660-nm wavelength band and the light in the 785-nm wavelength band whose electric vector oscillates in the Z-axis direction travels in the X-axis direction without being changed in polarization state by the wavelength selective optical rotator 10 and passes straight through the polarizing beam splitter 23. After passing though the polarizing beam splitter 23, the light is reflected by a mirror 24 toward the DVD/CD 27b, passes through a (wideband) quarter-wave plate 25b and an objective lens 26b, and is focused on the information recording surface of the DVD/CD. Reflected light passes through the objective lens 26b and the (wideband) quarter-wave plate 25b and is reflected toward the polarizing beam splitter 23 by the mirror with its electric vector oscillating in the Y-axis direction. In the return path 32b, the light is reflected by the polarizing beam splitter 23 toward the photodetector 28 and reaches it.

As described above, in the optical head device using laser beams having the three different wavelengths, the use of the wavelength selective optical rotator 10 makes it possible to control the polarization state each outward light has until reaching the corresponding optical disc. This makes it possible to realize an optical head device that can be reduced in size and the number of components and is high in the degree of freedom of designing. Although in this embodiment the rotation angle of the light in the 405-nm wavelength band is 90°, the invention is not limited to such a case. The rotation angle can be adjusted freely depending on the arrangement of optical components of an optical head device and the polarization direction of laser light.

### EXAMPLE 1

In this Example, a specific manufacturing method of a wavelength selective optical rotator will be described with reference to FIG. 1. Polyimide films were applied to transparent substrates 11a and 11b which had been coated with low-reflection coatings (not shown) and were fired. Alignment films 12a and 12b were obtained by rubbing the surfaces of the polyimide films. The transparent substrates on which the alignment films were formed were laid on each other in such a manner that the alignment films were opposed to each other and spacers of about 15 μm in diameter (not shown) were dispersed. A cholesteric-phase liquid crystal in which a chiral agent whose helical twist power (HTP) is 36.5 was added by 9.4 wt % to a nematic liquid crystal whose ordinary refractive index (nₒ) and extraordinary refractive index (nₑ) were 1.56 and 1.74, respectively, for light having a wavelength 405 nm was injected between the alignment films and polymerized by exposing it with ultraviolet light having a wavelength 365 nm. A cholesteric-phase liquid crystal layer 13 was thus formed. The pitch P in the thickness direction of the cholesteric-phase liquid crystal layer was about 300 nm, and a wavelength selective optical rotator whose selective reflection wavelength λ₀ was about 470 nm was realized.

Rotation angles of linearly polarized light beams that were output from the thus-manufactured wavelength selective optical rotator when linearly polarized light beams in a wavelength range of 350 to 800 nm were input to it perpendicularly to the transparent substrate surfaces were examined. FIG. 8 shows a relationship between the incident light wavelength and the rotation angle. Since the selective reflection wavelength λ₀ is 470 nm, incident light is reflected around 470 nm. Rotation angles of light beams having wavelengths 405 nm, 660 nm, and 785 nm were 87°, −7°, and −2°, respectively. As a result, good characteristics were obtained when this wavelength selective optical rotator was disposed in the optical head device 20.

### EXAMPLE 2

A wavelength selective optical rotator having the same configuration as the wavelength selective optical rotator of Example 1 except that the content of the chiral agent and the thickness of the cholesteric-phase liquid crystal layer were changed was manufactured. A cholesteric-phase liquid crystal in which a chiral agent whose HTP is 36.5 was added by 13.5 wt % to a nematic liquid crystal whose ordinary refractive index (nₒ) and extraordinary refractive index (nₑ) were 1.56 and 1.74, respectively, for light having a wavelength 405 nm was injected between the alignment films and polymerized by exposing it with ultraviolet light having a wavelength 365 nm. A 14-μm-thick cholesteric-phase liquid crystal layer 13 was thus formed. The pitch P in the thickness direction of the cholesteric-phase liquid crystal layer was about 200 nm, and a wavelength selective optical rotator whose selective reflection wavelength μ₀ was about 340 nm was realized.

Rotation angles of the thus-configured wavelength selective optical rotator were calculated, and it was found that light beams having wavelengths 405 nm, 660 nm, and 785 nm were given rotation angles −45°, −1.5°, and −0.5°, respectively. A wavelength selective optical rotator that functions as an optical rotator only at a wavelength 405 nm was thus realized.

### EXAMPLE 3

A wavelength selective optical rotator having the same configuration as the wavelength selective optical rotators of Examples 1 and 2 except that the content of the chiral agent and the thickness of the cholesteric-phase liquid crystal layer were changed was manufactured. A cholesteric-phase liquid crystal in which a chiral agent whose helical twist power HTP is 36.5 was added by 7.4 wt % to a nematic liquid crystal whose ordinary refractive index (nₒ) and extraordinary refractive index (nₑ) were 1.56 and 1.74, respectively, for light having a wavelength 405 nm was injected between the alignment films and polymerized by exposing it with ultraviolet light having a wavelength 365 nm. A 18-μm-thick cholesteric-phase liquid crystal layer 13 was thus formed. The pitch P in the thickness direction of the cholesteric-phase liquid crystal layer was about 370 nm, and a wavelength selective optical rotator whose selective reflection wavelength λ₀ was about 590 nm was realized.

Rotation angles of the thus-configured wavelength selective optical rotator were calculated, and it was found that light beams having wavelengths 405 nm, 660 nm, and 785 nm were given rotation angles 91°, −44°, and −8°, respectively. A wavelength selective optical rotator that functions as an optical rotator only at the wavelengths 405 and 660 nm was thus realized.

### EXAMPLE 4

A wavelength selective optical rotator having the same configuration as the wavelength selective optical rotators of Examples 1-3 except that the content of the chiral agent and the thickness of the cholesteric-phase liquid crystal layer were changed was manufactured. A cholesteric-phase liquid crystal in which a chiral agent whose helical twist power HTP is 36.5 was added by 7.8 wt % to a nematic liquid crystal whose ordinary refractive index (nₒ) and extraordinary refractive index (nₑ) were 1.56 and 1.74, respectively, for light having a wavelength 405 nm was injected between the alignment films and polymerized by exposing it with ultraviolet light having a wavelength 365 nm. A 28-μm-thick cholesteric-phase liquid crystal layer 13 was thus formed. The pitch P in the thickness direction of the cholesteric-phase liquid crystal layer was about 350 nm, and a wavelength selective optical rotator whose selective reflection wavelength λ₀ was about 560 nm was realized.

Rotation angles of the thus-configured wavelength selective optical rotator were calculated, and it was found that light beams having wavelengths 405 nm, 660 nm, and 785 nm were given rotation angles −47°, −41°, and −9°, respectively. A wavelength selective optical rotator that functions as an optical rotator only at the wavelengths 405 and 660 nm was thus realized.

### COMPARATIVE EXAMPLE

A wavelength selective optical rotator having the same configuration as the wavelength selective optical rotators of Examples 1 and 2 except that the content of the chiral agent and the thickness of the cholesteric-phase liquid crystal layer were changed was manufactured. A cholesteric-phase liquid crystal in which a chiral agent whose helical twist power HTP is 36.5 was added by 6.7 wt % to a nematic liquid crystal whose ordinary refractive index (nₒ) and extraordinary refractive index (nₑ) were 1.56 and 1.74, respectively, for light having a wavelength 405 nm was injected between the alignment films and polymerized by exposing it with ultraviolet light having a wavelength 365 nm. A 16-μm-thick cholesteric-phase liquid crystal layer 13 was thus formed. A wavelength selective optical rotator whose selective reflection wavelength X of the cholesteric-phase liquid crystal layer was about 660 nm was realized.

Rotation angles of the thus-configured wavelength selective optical rotator were calculated. For incident linearly polarized light beams having wavelengths 405 nm and 785 nm, rotation angles of 89° and−14° were obtained, respectively. However, for incident linearly polarized light having a wavelength 660 nm which was in the reflection wavelength band, circularly polarized light was output and the transmittance was approximately halved. Therefore, this wavelength selective optical rotator does not function as a useful optical rotator at this wavelength.

### INDUSTRIAL APPLICABILITY

As described above, a highly controllable wavelength selective optical rotator can be realized which can not only produce exit light whose polarization state is rotated by a prescribed angle for incident linearly polarized light having a particular wavelength but also produce rotation-angle-controlled exit light or exit light whose polarization state is not changed also for incident linearly polarized light beams having different wavelengths. This wavelength selective optical rotator is useful because it can be applied to optical systems such as optical head devices.

The present invention has been described above in detail using the particular embodiments. However, it is apparent to a person skilled in the art that various changes and modifications are possible without departing from the spirit and scope of the invention.

This application is based on Japanese Patent Application No. 2008-046268 filed on Feb. 27, 2008, the disclosure of which is incorporated herein by reference.

1. A wavelength selective optical rotator comprising a liquid crystal layer including a cholesteric-phase liquid crystal, wherein:
when a first linearly polarized light having a wavelength λ₁ is incident on the liquid crystal layer, the liquid crystal layer converts the first linearly polarized light into a second linearly polarized light is a different linearly polarized light from the first linearly polarized light and outputs the latter; and
when a linearly polarized light having a wavelength λ₂ that is longer than the wavelength λ₁ is incident on the liquid crystal layer, the liquid crystal layer outputs the linearly polarized light without changing its polarization state substantially.

2. The wavelength selective optical rotator according to claim 1, wherein
the first and second linearly polarized lights are approximately perpendicular to each other or form approximately 45°.

3. The wavelength selective optical rotator according to claim 1, wherein:
the cholesteric-phase liquid crystal has a reflection band for one of incident clockwise circularly polarized light and counterclockwise circularly polarized light; and
the wavelength λ₁ is located on the shorter wavelength side of the reflection band and the wavelength λ₂ is located on the longer wavelength side of the reflection band.

4. The wavelength selective optical rotator according to claim 3, wherein
when the first linearly polarized light having a wavelength λ₄ that is located on the longer wavelength side of the reflection band and on the shorter wavelength side of the wavelength λ₂ is incident on the liquid crystal layer, the liquid crystal layer converts the first linearly polarized light into the second linearly polarized light and outputs the latter.

5. The wavelength selective optical rotator according to claim 2, wherein:
the cholesteric-phase liquid crystal has a reflection band for one of incident clockwise circularly polarized light and counterclockwise circularly polarized light; and
the wavelengths λ₁ and λ₂ are both located on the longer wavelength side of the reflection band.

6. The wavelength selective optical rotator according to claim 1, wherein
a selective reflection wavelength of the cholesteric-phase liquid crystal is located at one point in a range of 300 to 610 nm.

7. The wavelength selective optical rotator according to claim 1, wherein
when linearly polarized light having a wavelength λ₃ that is located on the longer wavelength side of the wavelength λ₂ is incident on the liquid crystal layer, the liquid crystal layer outputs it without changing its polarization state substantially.

8. The wavelength selective optical rotator, comprising
two or more wavelength selective optical rotators, which are the same as at least one of the wavelength selective optical rotators according to claim 3, being laid on each other.

9. The wavelength selective optical rotator, comprising
two or more wavelength selective optical rotators, which are the same as at least one of the wavelength selective optical rotators according to claim 4, being laid on each other.

10. The wavelength selective optical rotator, comprising
two or more wavelength selective optical rotators, which are the same as at least one of the wavelength selective optical rotators according to claim 5, being laid on each other.

11. The wavelength selective optical rotator, comprising
two or more wavelength selective optical rotators, which are the same as at least one of the wavelength selective optical rotators according to claim 6, being laid on each other.

12. The wavelength selective optical rotator, comprising
two or more wavelength selective optical rotators, which are the same as at least one of the wavelength selective optical rotators according to claim 7, being laid on each other.

13. An optical head device comprising:
at least one light source for emitting the first linearly polarized lights having at least the wavelengths λ₁ and λ₂;
a beam splitter for deflection-separating the light beams emitted from the light source;
objective lenses for focusing light beams that are output from the beam splitter on optical recording media, respectively;
a photodetector for detecting light beams reflected from the respective optical recording media; and
the wavelength selective optical rotator according to claim 1 which is disposed in an optical path between the light source and the beam splitter.

14. The optical head device according to claim 13, wherein:
the optical head device comprises at least one light source for emitting the first linearly polarized lights and the wavelengths λ₁, λ₂, and λ₃, respectively; and
the wavelengths λ₁, λ₂, and λ₃ are in a 405-nm wavelength band, a 660-nm wavelength band, and a 785-nm wavelength band, respectively.
